(19) United States
(12) Patent Application Publication
(10) Pub. No.: US 2024/0310628 A1
(43) Pub. Date: Sep. 19, 2024

(54) VEHICLE HUD WITH EXTERNAL SCREEN PROJECTION

(71) Applicant: Ford Global Technologies, LLC, Dearborn, MI (US)

(72) Inventors: John Robert Van Wiemeersch, Novi, MI (US); Ryan Joseph Gorski, Grosse Pointe Farms, MI (US); Brendan Francis Diamond, Grosse Pointe, MI (US); Haibo Zhao, Northville, MI (US); Janice L. Tardiff, Plymouth, MI (US)

(73) Assignee: Ford Global Technologies, LLC, Dearborn, MI (US)

(21) Appl. No.: 18/184,879

(22) Filed: Mar. 16, 2023

(51) Int. Cl. G02B 27/01; B60K 35/00; H04N 7/18; H04N 9/31

(52) U.S. Cl. CPC G02B 27/0103; B60K 35/00; G02B 27/0149; H04N 7/181; H04N 9/3147; H04N 9/3185; B60K 35/23; B60K 35/60; B60K 2360/21; B60K 2360/29; B60K 2360/797; G02B 2027/0138; G02B 2027/014; G02B 2027/0154

(57) ABSTRACT

A first vehicle-integrated projector for a heads-up display projects an image through a vehicle windshield and onto a projection screen. The projection screen is mounted on the vehicle and positioned a predetermined distance beyond the vehicle windshield. The windshield includes a layer of holographic film. The image is keystone corrected to conform a shape of the image to be closer to a shape of the projection screen than an uncorrected shape of the image. The image is focused on the projection screen.

### BACKGROUND

A vehicle may be equipped with a heads-up display (“HUD”). A transparent display type of HUD includes a projector that projects an image onto a holographic optical element (“HOE”) of a laminated windshield. The laminated windshield has a holographic film layer disposed between glass layers. The holographic film layer defines the HOE. A field of view from which the image projected onto the HOE may be viewed is restricted to a first occupant having their eyes or eye disposed in an eye-box. The eye-box is a geometrically defined space inside the vehicle from which the first occupant may view the images projected onto the HOE by the HUD projector.

### BRIEF DESCRIPTION OF THE DRAWINGS

FIG. 1 is a block diagram illustrating an example image projection system for a vehicle.

FIG. 2 is a more detailed block diagram of the example image projection system of FIG. 1.

FIG. 3 is a schematic illustration of first example layers of a laminated windshield.

FIG. 4 is a side view of a driver in an example seated position in an example vehicle illustrating both an example image projection angle and an example viewing angle associated with an example projector.

FIG. 5 is a side view of an example vehicle with an example projector illustrating an example image projection angle.

FIG. 6 is a perspective view of an example projection screen for use with the example projection system of FIG. 1 and FIG. 2.

FIG. 7 is a side view of an example projection screen positioned relative to an example vehicle.

FIG. 8 is a plan view of the example projection screen and vehicle of FIG. 7.

FIG. 9 is a side view of the example projection screen supported by a first support linkage.

FIG. 10 is a plan view of the example projection screen supported by the first support linkage.

FIG. 11 is a side view of the example projection screen supported by a second support linkage.

FIG. 12 is a side view of the example projection screen supported by the second support linkage.

FIG. 13 is a side view of a second example projection screen support by a third mounting linkage.

FIG. 14 is a perspective view of the second example projection screen.

FIG. 15 is an example flow chart of an example process for reducing incidental projection of the example projector.

### DETAILED DESCRIPTION

As described herein, a vehicle image projection system controls a transparent display HUD. When a vehicle is stopped or parked, the use of the transparent display HUD may be extended to project images on a projection screen positioned in front of a windshield to allow multiple vehicle occupants to view a common image. Upon detecting conditions indicative of a request for an external projection of an image beyond the windshield of the vehicle by a vehicle-integrated projector of the HUD, the system directs the projector to project an image through the vehicle windshield and onto the projection screen mounted on the vehicle. Projection on the screen allows the image to be viewed by occupants in the vehicle without having their eye or eyes in an eye-box associated with the projector. The screen is positioned a predetermined distance beyond the windshield. The image is keystone corrected to substantially conform to the shape of the projection screen. The image is focused on the projection screen. A condition indicative of a request for external projection of the image may include sensing that the vehicle is in a parked condition. Another condition indicative of a request for external projection of the image may include a selection by a vehicle operator or a passenger of a menu item in a control menu for the projector.

Advantageously, as described herein, a computing device comprises a processor and a memory. The memory of the vehicle image projection system stores instructions executable by the processor such that the computer is programmed to execute such instructions. Such instructions may include the following. Upon detecting conditions suited to do so, an image is projected from a first vehicle-integrated projector for a heads-up display through a vehicle windshield onto a projection screen. The projection screen includes a layer of holographic film. The projection screen is mounted on the vehicle at a predetermined distance beyond the vehicle windshield. The image is keystone corrected to a more rectangular shape than an uncorrected shape. The image is focused on the projection screen.

The computing device may be further programmed to consider additional factors prior to scheduling the sending of any message or messages to the user device as per the below clauses. To the extent that such features are not mutually exclusive, they may be combined with each other.

The projection screen may be substantially manually positioned at an angle greater than an angle of a plane tangent to the windshield.

The first vehicle-integrated projector may be one of at least three vehicle-integrated projectors positioned to direct respective projection beams toward the windshield. The first vehicle-integrated projector may be laterally disposed between the other vehicle-integrated projectors.

A second vehicle-integrated projector may also project an image onto the projection screen.

The image projected by the second vehicle-integrated projector may include data descriptive of the image projected by the first vehicle-integrated projector.

A picture-in-picture image may be projected within a larger projection image wherein the picture-in-picture image is of video from a vehicle-mounted camera oriented to provide an image of activity outside of the vehicle.

The vehicle-mounted camera comprises one of a plurality of cameras collectively providing exterior views around the vehicle.

The projection screen may be supported by a hood of a vehicle and the hood is in an open position.

The projection screen may be fixed to the hood when the hood is closed.

The projection screen may be substantially planar and rigid.

The projection screen is rollable.

The projection screen may comprise a plurality of lateral slats.

A darkening shroud may extend laterally and vertically beyond the projection screen, and axially toward the windshield.

The darkening shroud may comprise a foldable material defining living hinges, and a stiffening panel sized to bridge a distance between an upper edge of the projection screen and a roof of the vehicle.

The darkening shroud may extend across an entirety of the windshield.

The darkening shroud may extend axially from at least the projection screen to rearward of a windshield.

A method of projecting an image with a HUD projector for viewing by occupants in a vehicle without having their eye or eyes in an eye-box associated with the projector is set forth below.

A method of viewing of an image from a HUD projector projecting beyond a windshield includes a plurality of steps including the following. An image from a passenger-side vehicle-integrated projector for a heads-up display is projected onto a vehicle windshield including a layer of holographic film. Upon detecting a sensed condition indicative of a possible projection of the image onto a surface beyond the windshield, projection of the image is adjusted to diminish a visibility of the projection of the image beyond the windshield independent of headlight activation.

A method of projecting images from a vehicle-integrated projector for viewing by a vehicle occupant includes the following steps. A vehicle-mounted projection screen is positioned a predetermined distance beyond a vehicle windshield including a layer of holographic film. An image is projected from a first vehicle-integrated projector for a heads-up display onto the projection screen. The image is keystone corrected to a more rectangular shape than an uncorrected shape. The image is focused on the projection screen.

Additional steps that may be included are set forth below. Such additional steps may be combined with each other to the extent that they are not mutually exclusive.

The projection screen may be positioned at an angle greater than an angle of a plane tangent to the windshield.

The projection screen may be supported by a hood of a vehicle and the hood is in an open position.

A darkening shroud may be provided that extends laterally and vertically beyond the projection screen and extending axially toward the windshield.

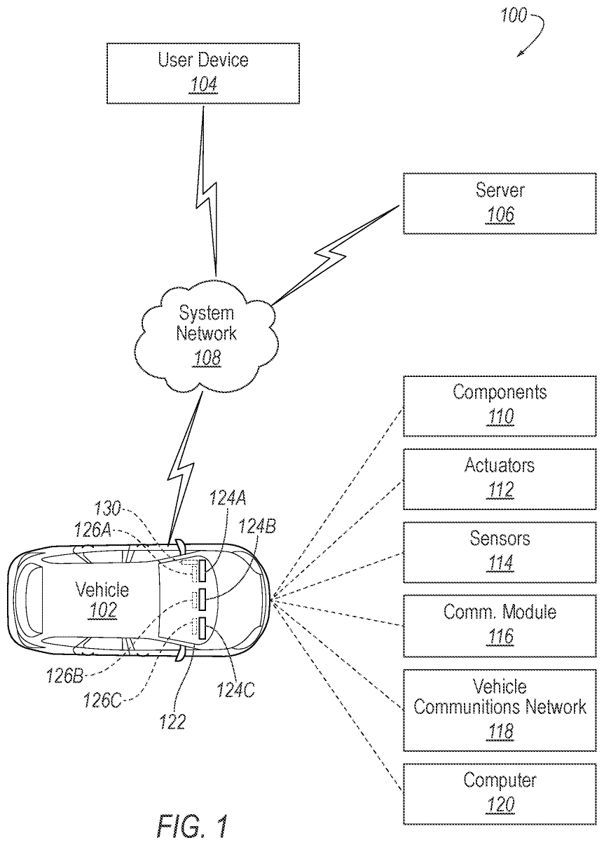

With reference to FIGS. 1-15, a system and method for enhancing viewing of an image from a HUD projector projecting beyond a window are disclosed as set forth below.

With particular reference to FIG. 1, an example vehicle image projection system 100 may include the following example elements: a vehicle 102, a user device 104, a server 106, and a system network 108.

The vehicle 102 includes a plurality of vehicle components 110, a plurality of vehicle actuators 112, a plurality of vehicle sensors 114, a vehicle communication module 116, a vehicle communications network 118, and a vehicle computer 120.

In the context of the present disclosure, a vehicle component 110 is one or more hardware components adapted to perform a mechanical or electro-mechanical function or operation-such as moving the vehicle 102, slowing or stopping the vehicle 102, steering the vehicle 102, displaying information, etc. Non-limiting examples of components 110 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a brake component, a park assist component, an adaptive cruise control component, an adaptive steering component, one or more restraint systems, a movable seat, a door lock component, headlights, dashboard instrumentation, an in-vehicle dashboard display screen, a window 122, an example window being a windshield 122, incorporating a holographic film layer having one or more holographic optical elements formed thereon to define one or more corresponding substantially transparent HUD screens 124A, 124B. 124C, digital light HUD projectors 126A, 126B, 126C, a virtual HUD projector 130, etc. Substantially transparent means that, to the naked eye of an observer, the HUD screens 124A, 124B, 124C would be perceived as transparent by the observer unless light were projected at the screens 124A, 124B, 124C at a predetermined angle and the observer had an eye or eyes in a predetermined location, i.e., an eye-box, as described in more detail below.

The vehicle actuators 112 are implemented via circuits, chips, or other electronic and or mechanical components that may actuate various vehicle subsystems in accordance with appropriate control signals as is known. The actuators 112 may be used to control the components 110, including brake components for braking, propulsion components for acceleration, steering components for steering of a vehicle 102, and door lock components for locking vehicle doors.

Vehicle sensors 114 may include a variety of devices such as are known to provide data to the vehicle computer 120. For example, the sensors 114 may include Light Detection And Ranging (LIDAR) sensors 114 that provide relative locations, sizes, and shapes of objects, including people, surrounding the vehicle 102. As another example, one or more radar sensors 114 may provide data to provide locations of the objects, second vehicles, etc., relative to the location of the vehicle 102. The sensors 114 may further alternatively or additionally, for example, include vehicle-mounted cameras 114, e.g., front view cameras, side view cameras, rear view cameras, etc., individually and collectively providing images from an area surrounding the vehicle 102. As another example, the vehicle 102 may include one or more sensors 114, e.g., cameras 114, mounted inside a cabin of the vehicle 102 and oriented to capture images of users, including a vehicle operator, i.e., a driver, in the vehicle 102 cabin. In the context of this disclosure, an object is a physical, i.e., material, item that has mass and that can be represented by physical phenomena (e.g., light or other electromagnetic waves, or sound, etc.) detectable by sensors 114. Other sensors 114 may include seat pressure sensors 114 able to sense the presence of a weight on a seat, and ambient light sensors 114 capable of determining a magnitude of ambient light outside of the vehicle. Thus, the vehicle 102, and people, as well as other items including as discussed below, fall within the definition of “object” herein. Additional example sensors 114 may also include steering sensors, drive motor sensors, brake sensor, wheel speed sensors, and battery sensors.

The vehicle communication module 116 allows the vehicle computer 120 to communicate with a remote computer (not shown) of the server 106, and/or the user device 104, by way of example, a messaging or broadcast protocol such as Dedicated Short Range Communications (DSRC), Cellular Vehicle-to-Everything (C-V2X), Bluetooth® Low Energy (BLE), Ultra-Wideband (UWB), Wi-Fi, cellular, and/or other protocol that can support vehicle-to-vehicle, vehicle-to-structure, vehicle-to-cloud communications, or the like, and/or via the system network 108.

The vehicle computer 120 is a computing device that includes a processor and a memory such as are known. The memory includes one or more forms of computer-readable media, and stores instructions executable by the vehicle computer 120 for performing various operations, including as disclosed herein. The vehicle computer 120 may further include two or more computing devices operating in concert to carry out vehicle 102 operations including as described herein. Further, the vehicle computer 120 may be a generic computer with a processor and memory as described above and/or may include a dedicated electronic circuit including an ASIC (application-specific integrated circuit) that is manufactured for a particular operation, e.g., an ASIC for processing sensor 114 data and/or communicating the sensor 114 data. In another example, the vehicle computer 120 may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in the vehicle computer 120.

The vehicle computer 120 may include or be communicatively coupled, an example coupling provided by the vehicle communication network 118 such as a communications bus as described further below, to more than one processor, e.g., included in electronic controller units (ECUs) or the like included in the vehicle 102 for monitoring and/or controlling various vehicle components 110, e.g., a transmission controller, a brake controller, a steering controller, etc. The vehicle computer 120 is generally arranged for communications on the vehicle communication network 118 that may include a communication bus in the vehicle 102 such as a controller area network (CAN) or the like, and/or other wired and/or wireless mechanisms including Wi-Fi, UWB, and Bluetooth®.

Via the vehicle communication network 118, the vehicle computer 120 may transmit messages to various devices in the vehicle 102 and/or receive messages (e.g., CAN messages) from the various devices, e.g., sensors 114, actuators 112, ECUs, etc. Alternatively, or additionally, in cases where the vehicle computer 120 comprises a plurality of computing devices that may be associated with particular components and systems of the vehicle 102, the vehicle communication network 118 may be used for communications between the computing devices which may be represented as the vehicle computer 120 in this disclosure. Further, as mentioned below, various controllers and/or sensors 114 may provide data to the vehicle computer 120 via the vehicle communication network 118.

The vehicle computer 120 is programmed to receive data from one or more sensors 114, e.g., substantially continuously, periodically, and/or when instructed by the remote computer of the server 106, etc. The data may, for example, include a location of the vehicle 102. Location data specifies a point or points on a ground surface and may be in a known form, e.g., geo-coordinates such as latitude and longitude coordinates obtained via a navigation system, as is known, that uses the Global Positioning System (GPS) and/or dead reckoning. Additionally, or alternatively, the data may include a location of an object, e.g., a vehicle 102, a sign, a tree, a person, etc., relative to the vehicle 102. As one example, the data may be image data of the environment around the vehicle 102. In such an example, the image data may include one or more objects and/or markings, e.g., lane markings, on or along a road. Image data herein means digital image data, i.e., comprising pixels, typically with intensity and color values, that may be acquired by cameras 114. The sensors 114 may be mounted to any suitable location in or on the vehicle 102, e.g., on a vehicle 102 bumper, on a vehicle 102 roof, etc., to collect images of the environment around the vehicle 102.

In addition, the vehicle computer 120 may be configured for communicating via the vehicle communication module 116 and the system network 108 with devices outside of the vehicle 102, e.g., with the user device 104 and the server 106, using wireless communications (cellular and/or C-V2X, etc.) or direct radio frequency communications. The communication module 116 may include one or more mechanisms, such as a transceiver, to facilitate such communication, and may employ any desired combination of wireless (e.g., cellular, wireless, satellite, microwave, audio, ultrasonic, and radio frequency) communication mechanisms and any desired network topology (or topologies when a plurality of communication mechanisms are utilized). Exemplary communications provided via the communication module 116 include cellular, Bluetooth®, IEEE 802.11, Ultra-Wideband (UWB), Near Field Communication (NFC), dedicated short range communications (DSRC), Cellular Vehicle-to-Everything (C-V2X), and/or wide area networks (WAN), including the Internet, providing data communication services.

The remote server 106 may be a conventional computing device, i.e., including one or more processors and one or more memories, programmed to provide operations such as disclosed herein. Further, the remote server 106 may be accessed via the network 108, e.g., the Internet, a cellular network, and/or or some other wide area network, particular forms of which may be characterized as a cloud server 106.

The system network 108 represents one or more mechanisms by which a vehicle computer 120 may communicate with remote computing devices, e.g., the remote computer of the server 106, another vehicle computer, etc. Accordingly, the network 108 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), UWB, NFC, IEEE 802.11 including Wi-Fi, vehicle-to-vehicle (V2V) such as Dedicated Short-Range Communications (DSRC), etc.), local area networks (LAN) and/or wide area networks (WAN), including the Internet, providing data communication services).

An example user device 104 may be provided by a smartphone 104 or a purpose-specific wireless communication device incorporating a suitable vehicle control software application. The user device 104, like other elements of the vehicle image projection system 100, may include hardware suited to connecting to wireless communication networks (e.g., using Bluetooth®, Bluetooth® Low Energy (BLE), UWB, NFC, IEEE 802.11 including Wi-Fi, vehicle-to-vehicle (V2V) such as Dedicated Short-Range Communications (DSRC), C-V2X, etc.), local area networks (LAN) and/or wide area networks (WAN), including the Internet, providing data communication services).

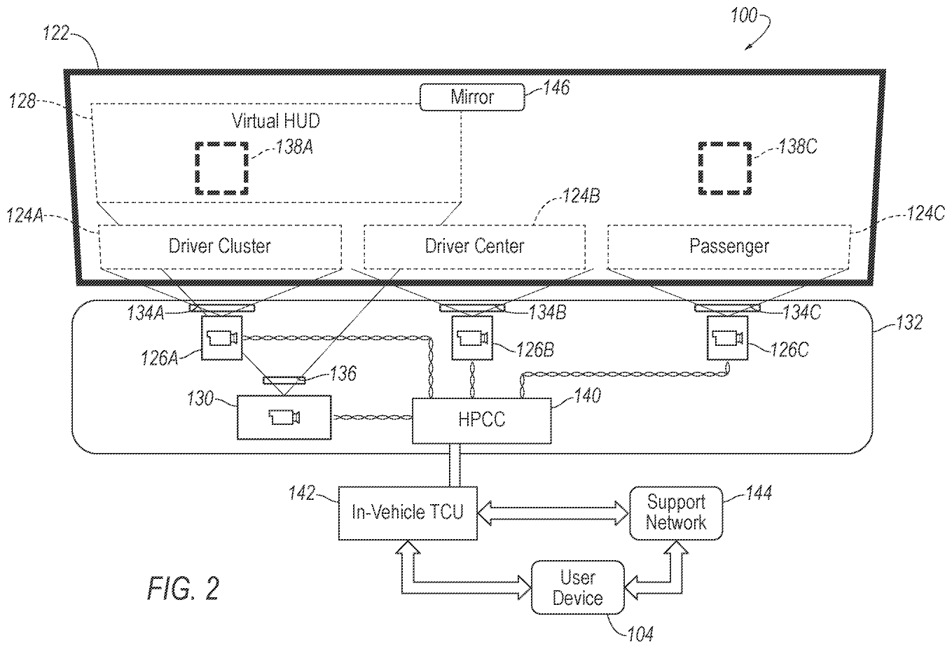

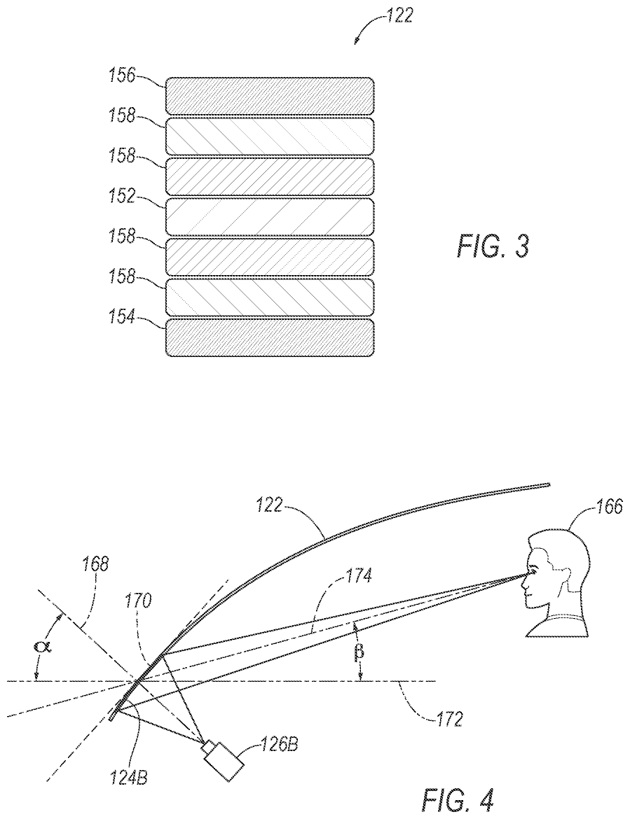

The vehicle image projection system 100 as illustrated in FIG. 2 includes the example window 122, i.e., the windshield 122, that includes the substantially transparent HUD screens 124A, 124B, and 124C. The windshield 122 has a laminated structure, described below in the context of FIG. 3, which includes a holographic film layer 152. The holographic film layer 152 may be formed of a photopolymer film that may extend across the entire windshield 122 and include one or more discrete areas upon which holographic optical elements (“HOEs”) are formed, e.g., etched. Each of the HUD screens 124A, 124B, and 124C are defined by a corresponding HOE of the holographic film layer 152. Based on the relative positioning of each of the screens 124A, 124B, and 124C, and given a left-drive vehicle in which a vehicle operator, i.e., a driver, is intended to be seated on a left side of the vehicle 102, the leftmost HUD screen 124A may be referenced to as a driver cluster screen 124A, the HUD screen 124B to the right of the screen 124A may be referenced to as the driver center screen 124B, and the right-most HUD screen 124C may be referenced to as the passenger screen 124C.

There may be separate transparent display digital light HUD projectors 126A, 126B, and 126C, alternatively referenced to as TD HUD projectors herein, associated with each of the HUD screens 124A, 124B, and 124C. Similar to the above-described approach to naming the HUD screens 124A, 124B, and 124C, the TD HUD projectors 126A, 126B, and 126C may be respectively referenced to as, from left to right, a driver cluster projector 126A, a driver center projector 126B, and a passenger projector 126C. Any one of the projectors 126A, 126B, 126C may be referenced to as a first projector or a second projector or a third projector. The reference to a first projector indicates the presence of at least one projector. The reference to a second projector indicates the presence of at least two projectors. The reference to a third projector indicates the presence of at least three projectors.

The vehicle operator's view of the windshield 122 may include a virtual HUD viewing area 128 in which the operator is able to view information projected by the virtual HUD projector 130. The virtual HUD viewing area 128 is a portion of the windshield 122 on which or beyond which an image provided by the virtual HUD projector 130 may be viewed by the operator.

The projectors 126A, 126B, 126C are integrated into the vehicle 102. Each of the projectors 126A, 126B, 126C, and 130 may be disposed beneath or behind a dashboard 132. The dashboard 132, from a perspective of a vehicle operator seating position, is disposed in a forward portion of an interior of the vehicle 102 and below the windshield 122. The dashboard 132 may extend a full width of the interior of the vehicle 102. The dashboard 132 may be alternatively referenced to as an instrument panel 132.

When the projectors 126A, 126B, 126C, and 130 are all disposed beneath or behind a dashboard 132, provision must be made for light to pass from the projectors 126A, 126B, 126C, and 130 to a viewing area for each. Such provision may be provided by apertures 134A, 134B, 134C, and 136 in the dashboard. The dashboard 132 of FIG. 2 is schematically illustrated as providing a driver cluster aperture 134A, a driver center aperture 134B, a passenger aperture 134C, and a virtual HUD aperture 136, each aperture 134A, 134B, 134C, and 136 respectively aligned with projectors 126A, 126B, 126C, and 130. In some applications, aperture 136 and aperture 134A may be combined into one larger aperture for projectors 126A and 130. Alternatively, apertures 134A and 134B may be combined into a single aperture. In yet another configuration, apertures 134A, 134B and 136 may all be combined into a single aperture.

The TD HUD projectors 126A, 126B, 126C are positioned and oriented to respectively project images onto the HUD screens 124A, 124B, and 124C. The virtual HUD projector 130 may project an image having the appearance of being beyond the windshield 122 viewable in the virtual HUD viewing area 128 without a screen in the windshield 122. The images on the HUD screens 124A, 124B, and 124C that are projected by the TD HUD projectors 126A, 126B, and 126C are only viewable from predetermined positions within the vehicle. The predetermined positions are specific to each of the HUD screens 124A, 124B, and 124C. Likewise, the image projected by the virtual HUD projector 130 is only viewable from a predetermined position within the vehicle. A first occupant seated in a first predetermined position, for example, a vehicle operator design-intent position, may be able to see the image projected by the virtual HUD projector 130 and the image projected onto the screen 124A by the driver cluster projector 126A and the image projected onto the screen 124B by the driver center projector 126B. With limited exceptions, discussed below, occupants other than the first occupant, seated in their respective design-intent positions within the vehicle, are not able to see the images projected by the HUD projectors associated with the design-intent seating position of the first occupant. Similarly, the other occupants may each have their seating positions associated with a HUD that projects images only viewable from an eye-box associated with their design-intent seating position. For example, a second occupant seated in a second predetermined position, for example, a front-seat passenger design-intent position, may be able to see the image projected by the passenger projector 126C onto the screen 124C. Other occupants, including the vehicle operator, would not be able to see the image on the screen 124C.

Each of the predetermined positions for viewing the images on the HUD screens 124A, 124B, and 124C and the image provided by the virtual HUD projector 130 may be defined by an eye-box 138A and 138C for each. The eye-boxes for each of the driver cluster screen 124A, the driver center screen 124B, and the image from the virtual HUD projector 130 may overlap and may be substantially the same as each other and aggregated in a first eye-box identified herein as a driver eye-box 138A. The eye-box for the passenger screen 124C is a second eye-box identified herein as a passenger eye-box 138C. While the eye-boxes 138A and 138C are shown as being rectangular in FIG. 2, the eye-boxes may be, by way of example, spherical or ovoid.

The example projectors 126A, 126B, 126C, and 130 may each be in electronic communication with an example projector controller 140 as may be provided by a high performance computer cluster 140, alternatively referenced to as an HPCC 140. Such electronic communication may be effected wirelessly or by wire, as may be provided by the vehicle communication network 118. The projector controller 140 may provide image data to each of the projectors 126A, 126B, 126C, and 130. The projector controller 140 may comprise part of the computer 120.

The projector controller 140 may be in electronic communication, effected either by wire or wirelessly, with an in-vehicle telematics control unit 142 which may alternatively be referenced to as a TCU 142. The projector controller 140 may receive image data for each of the projectors from the TCU 142. The TCU 142 may comprise at least a part of the communication module 116.

The TCU 142 may also electrically communicate with, both sending data to and receiving data from, the user device 104. Data from the user device 104 may include entertainment content streamed from the internet which may be accessed in the form of cellular data available from public and subscription cellular data services. Data to the user device 104 may include commands made by a vehicle operator or a front seat passenger on an in-vehicle dashboard display screen 110, comprising one of the vehicle components 110, located, by way of example in the dashboard 132 or in a center console of the vehicle, below the dashboard 132. The in-vehicle display screen 110, when included, may also be in electronic communication with the TCU 142. The TCU 142 may be connected to the user device 104 wirelessly, via Wi-Fi or Bluetooth® or UWB, or by wire, as with a cable having appropriately compatible termination ends, such as, by way of example, a USB plug or a USB-C plug.

The TCU 142 may also electrically communicate with, both sending data to and receiving data from, a proprietary support network 144. The proprietary support network 144 may comprise elements of each of the server 106 and the system network 108. The electronic communication between the TCU 142 and the proprietary network may be, by way of example, via cellular data, satellite data communication, UWB or Wi-Fi communication. An example proprietary support network is found in the Ford Service Delivery Network. The user device 104 may also be in electronic communication with the proprietary support network 144.

FIG. 2 includes a schematic representation of an example rear-view mirror 146 to aid in illustrating the relative positions of the screens 124A, 124B, 124C and the eye-boxes 138A and 138C.

FIG. 3 is a schematic illustration of a first example of lamination layers of the windshield 122 in the regions of the windshield comprising the driver cluster screen 124A, the driver center screen 124B, and the passenger screen 124C. A key layer is the holographic film layer 152. The holographic film layer 152 has its HOEs configured uniquely and specifically for each of the screens 124A, 124B, and 124C to provide reflections of images projected onto each screen by the respective TD HUD projectors 126A, 126B and 126C only to the targeted eye-boxes 138A and 138C. In the case of the screens 124A and 124B, the reflected images thereof may only be viewed at a design-intent clarity by a person sitting in a vehicle operator seat with at least one of their eyes disposed in the eye-box 138A. In the case of the passenger screen 124C, the reflected images thereof may only be viewed at the design-intent clarity by a person sitting in a vehicle front passenger seat, i.e., a front seat passenger, with at least one of their eyes disposed in the eye-box 138C. Reduced clarity viewing of the screens 124A and 124B may be possible for a passenger, i.e., a viewer, in the vehicle 102 seated in back of the operator when the eye-box 138A expands conically in a rearward direction away from the screens 124A and 124B. Similarly, reduced clarity viewing of the screen 124C may be possible for a passenger in the vehicle 102 seated in back of the front passenger when the eye-box 138C expands conically in a rearward direction away from the screen 124C.

As further shown in FIG. 3, the holographic film layer 152 may be disposed between a first glass layer 154 and a second glass layer 156. The holographic film layer 152 may be supplemented by a plurality of transparent supplemental film layers 158 disposed between the holographic film layer 152 and the glass layers 154 and 156. Example supplemental film layers 158 may include one or more of any of a polyvinyl butyral film layer, a polyamide film layer, and a polyethylene terephthalate film layer, i.e., a PET film layer. Laminated windshields incorporating the holographic film layer 152 are available from, by way of example, Ceres Holographics, Ltd. of Livingston, Scotland.

FIG. 4 shows a vehicle operator 166 viewing an image on the driver center screen 124B as projected by the driver center projector 126B. The driver center projector 126B is oriented upward from a location below the driver center screen 124B to project along a projection axis 168 that may be substantially normal to a windshield tangential plane 170. The windshield 122 is curved relative to at least two axes, resulting in the windshield tangential plane 170 being tangent to the windshield 122 at a single point. The windshield tangential plane 170 is tangent to the windshield 122 and the driver center screen 124B at a point where the projection axis 168 intersects the windshield 122. The projection axis 168 is oriented at a projection angle α relative to a horizontal plane 172. An angle of the tangential plane 170 to the horizonal plane 172 may thus be expressed in radians as (π/2−α), or, when using units of degrees, (90−α). An example value of α may be 61 degrees, and the corresponding example value of the angle of the tangential plane 170 to the horizontal plane 172 may be 29 degrees.

The operator 166 views the image on the driver center screen 124B along a viewing axis 174 oriented at a viewing angle β relative to the horizontal plane 172. The viewing angle β may be determined by considering factors that may include a location of the operator's eyes relative to the driver center screen 124B and the image projected thereon, a distance of the operator's eyes from the driver center screen 124B, a vertical distance between the operator's eyes and a center of the driver center screen 124B, the optical characteristics of the holographic film layer 152, the slope of the windshield, and the projection angle α. An example value of the angle β may be in a range of six to seven degrees. The operator's eyes must be in the driver eye-box 138A to view the projection image on the driver center screen 124B. While only the geometry for the driver center screen 124B and driver center projector 126B are illustrated, the geometries for the other screens 124A, 124C and projectors 126A, 126C may be substantially similar.

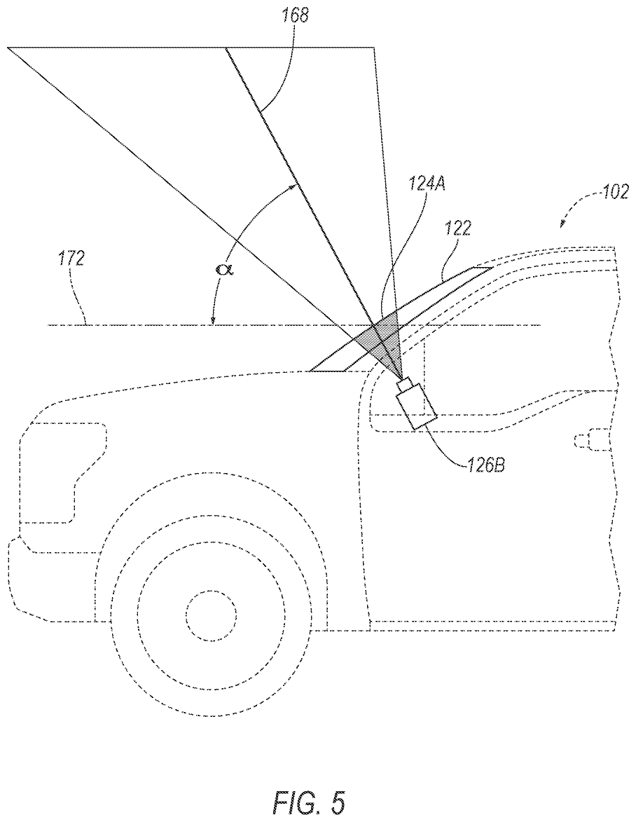

FIG. 5 illustrates a projection of light from the driver center projector 126B along the projection axis 168 beyond the driver center screen 124B. The driver center projector 126B and the driver center screen 124B are shown in a more complete vehicle setting than in FIG. 4. The geometric elements are as set forth above in the description of FIG. 4.

The HUD screens 124A, 124B, and 124C reflect only a portion of the light projected thereonto as an image viewable by, depending on the HUD screen location, the vehicle operator or the front seat passenger. Much of the light not reflected back as an image on the respective HUD screen 124A, 124B, 124C, an example portion being 60 percent, passes through the HUD screen 124A, 124B, 124C. A projector emitting 400 lumens of light may thus yield a beyond-windshield projection intensity of 240 lumens of light. The light passing through and beyond the screen 124A, 124B, 124C, transmitted along the projection axis 168, may be harnessed to allow a sharing of images from the TD HUD projectors 126A, 126B, 126C with other occupants of the vehicle 102.

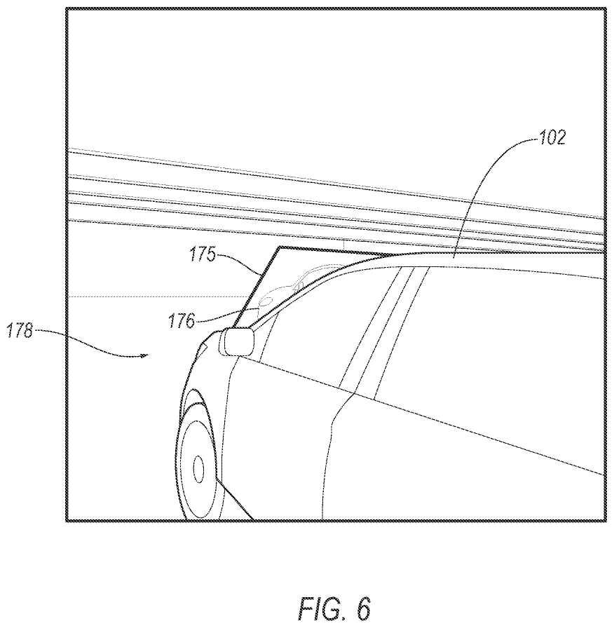

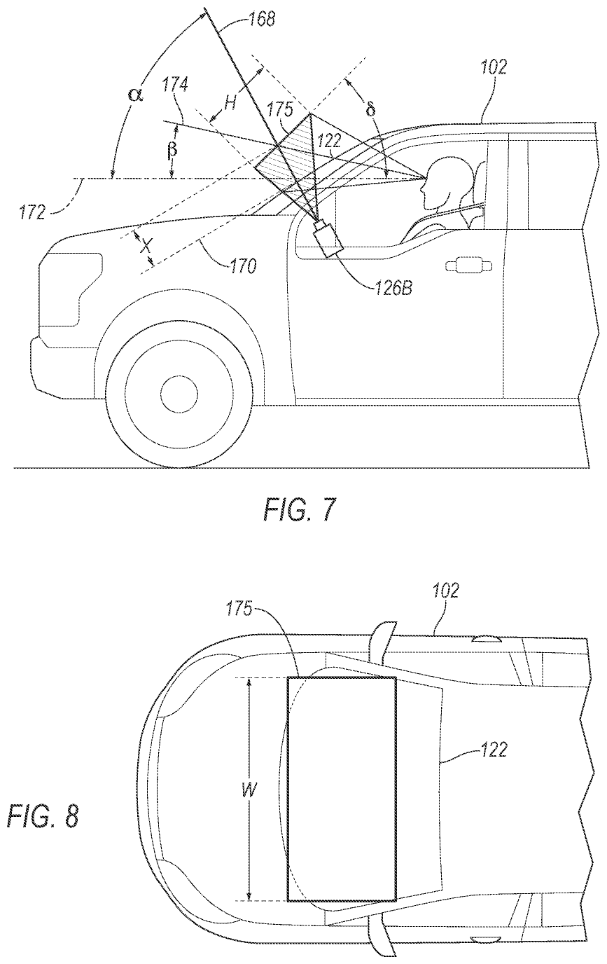

FIG. 6 shows the vehicle 102 with an example projection screen 175 positioned beyond the windshield 122. As shown in FIG. 7, the screen 175 is positioned at an angle δ relative to the horizontal plane 172. The screen 175 is shown without a support structure in FIGS. 6 and 7. Screen support structures are described below.

The projection screen 175 may be opaque to maximize a gain characteristic, i.e., gain, of the screen 175 to in turn maximize a brightness and clarity of a projection image 176 to the viewers inside the vehicle 102. The projection screen 175 may still function adequately if translucent rather than opaque. If translucent, the projection screen 175 may reduce the gain of the projection image 176, as some of the projected light will project through the projection screen 175, making the projection image 176 less bright on the screen 175, and thus less clear to the viewers than if the screen 175 was opaque.

The gain of the projection screen 175 at angles other than 90 degrees is also a factor to be considered in selecting a screen material. For example, the projection image 176, when projected by the projector 126A along the projection axis 168 and viewed by the vehicle operator 166 along the viewing axis 174, will be affected by both an angle of the projection axis 168 relative to the screen 175, e.g., (180−(α+δ)) degrees, and an angle of the viewing axis 174 relative to the screen 175, e.g., (δ+β) degrees. Variance of either angle from 90 degrees may decrease the gain of the image 176 on the screen 175 as viewed by the viewer, e.g., the vehicle operator 166. So, material for the screen 175 should be selected to maximize gain at acute angles for each of the projection axis 168 and the viewing axis 174. The details of the surface of the projection screen 175 and the material of the screen 175, beyond it being opaque, may be left as a design choice. Additionally, the screen angle δ needs to be selected to avoid having either the viewing angle or the projection angle be in a range in which the gain drops too low to allow clear viewing of the image 176. If either of the angles, i.e., the projection angle to the screen (180−(α+δ)) or the viewing angle to the screen (δ+β), gets too close to zero or 180 degrees, viewing of the image 176 will be compromised. The angle δ is greater than the angle of the tangential plane 170 which may equal, in degrees, (90−α). Independent of the material chosen for the projection screen 175, an example appropriate screen angle δ may substantially equalize the angle of the projection axis 168 relative to the screen 175 and the angle of the viewing axis 174 relative to the screen to each other, with, in units of degrees, δ=90−(α+β)/2.

A size of the projection screen 175 will vary with the vehicle 102 and its anticipated positioning. The projection screen 175 may be rectangular with a width W and a height H. The screen 175, when in use, will be oriented at the angle δ to the horizontal plane 172. The projection screen 175 may be spaced a distance X from the tangential plane 170 at a location where the projection axis 168 intersects the screen 175. A size and a positioning of the projection screen 175, when optimized to the vehicle 102, will vary with a plurality of factors that may include a width and height of the windshield 122, a location and orientation of the TD HUD projectors 126A, 126B, 126C including the projection angle α, and a range of locations of the expected location of the eyes of vehicle occupants, i.e., in-vehicle viewers, such as the driver 166. Packaging concerns, as for storage when the screen 175 is not in use, may also influence the size of the screen 175.

The projection screen 175, in anticipation of its use, is placed within a view of the viewers in the vehicle. The screen 175 may be positioned so that substantially all of the image 176 as provided by the projector 126A, 126B, 126C may be seen by the viewers from inside the vehicle, while also maximizing a size of the image 176 for viewing from within the vehicle 102.

The view of an upper portion of the screen 175 from within the vehicle may be limited by an upper portion of a windshield mounting frame of the vehicle 102. Depending on how close the viewer is to the windshield 122 and a location of the eye or eyes of the viewer, the viewer may be able to see above the upper edge of the windshield 122 from inside the vehicle 102. While it may be possible for occupants of the vehicle 102 to see above the windshield mounting frame when the vehicle 102 is equipped with, for example, a convertible roof or a transparent roof (e.g., sun roof, moon roof), it is expected that viewing will be limited to viewing through the windshield when the screen 175 is in use. To facilitate viewing from within the vehicle 102 for the most number of viewers therein, an upper limit of a viewing area of the projection screen 175 may be substantially limited to not extending above the upper edge of the windshield 122. When it is desired to limit a size of the screen, the upper edge of the screen may be coincident with the upper limit of the viewing area of the screen. A location of the upper edge of the screen 175, or at least the upper limit of the viewing area thereof if the screen extends therebeyond, may thus be established as an intersection of the top of an in-vehicle viewing range, and a top edge of the image projection along the axis 168. When the angle δ is known, the distance X of the projection screen 175 from the windshield 122 may be so established.

With the location of the projection screen 175 established, the location of the lower edge of the screen 175, and thus a necessary height H, may be determined by where a lower edge of the image 176 strikes the screen 175. The lower edge of the screen 175 may extend yet lower for, by way of example, mounting purposes, but need not for viewing purposes. It is expected that a viewer watching from the eye-box of the relevant HUD screen 124A, 124B, 124C may see the projection image 176 behind the image on the HUD screen 124A, 124B, 124C.

As the projection axis 168 of selected projector 126A, 126B, 126C will not be at 90 degrees to the screen 175, the uncorrected projection image 176 may have a trapezoidal shape, i.e., a “keystone” shape, on the screen. The image 176 may be keystone corrected, i.e., subjected to keystone correction, to correct the image to a more rectangular shape than an uncorrected shape. Keystone correction of images may be performed optically or digitally, or a combination of the two. The more rectangular shape of the projection image 176 may enhance overall visibility of the projection image. Keystone correction may diminish some aspects of the visibility of the projection image, as some localized blurring might occur. Also, the projection image 176 after keystone correction may be reduced in overall size compared to the uncorrected trapezoidal projection image. Accordingly, the image 176 may not always be keystone corrected to a true rectangular shape.

When it is desired to use the projection screen 175 to share images with in-vehicle viewers, the brightness of the projection image 176 relative to the ambient lighting needs to be great enough so that the image 176 may be perceived by the in-vehicle viewers. If the vehicle 102 is in too bright of a location, as in daylight, it may make it difficult for in-vehicle viewers to see the projection image 176 on the screen 175 clearly. The system 100, based on data from the ambient light sensor 114, may check for an ambient light level outside of the vehicle that is below a predetermined ambient light level before it allows the TD HUD projectors 126A, 126B, 126C to be used in a screen projection mode in which the image 176 to be viewed is on the screen 175 rather than a HUD projection mode in which the image or images are on the screens 124A, 124B, 124C. A dark location 178, such as a parking structure or a garage 178 may be used to enable the screen projection mode. Alternatively, as described in more detail below, a darkening shroud, may be employed to enable the screen projection mode when a dark location is not available, or when there is a desire to prevent the projection images 176 from being seen by anyone outside of the vehicle 102.

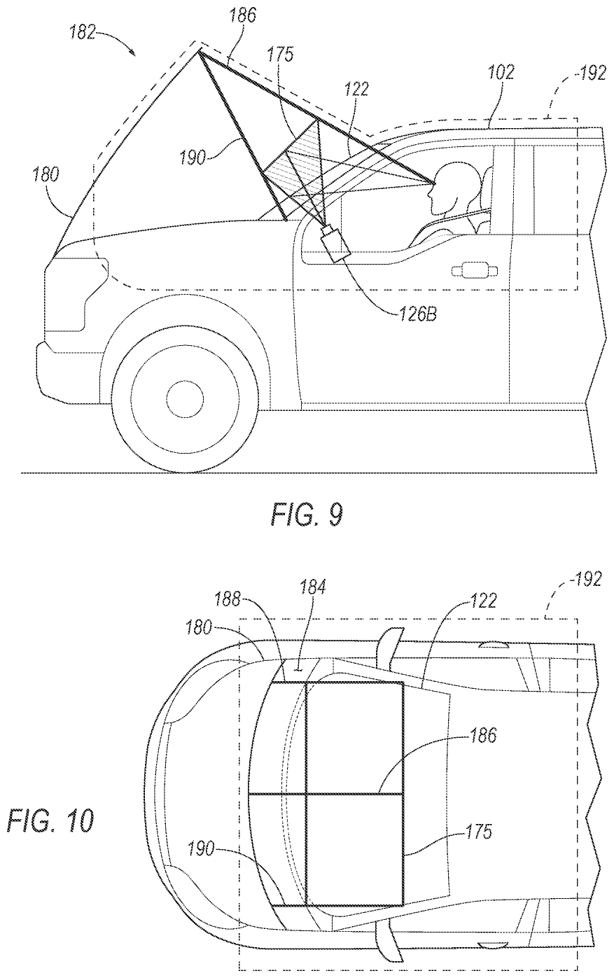

FIGS. 9 and 10 illustrate a first example support linkage 182 for the screen. The linkage 182 incorporates a hood 180 of the vehicle to support the screen 175 when the hood 180 is in an open position. The projection screen 175 may be connected to the hood 180 by the support linkage 182, with the hood 180 comprising part of the support linkage 182. The screen 175 may be rigid, i.e., self-supporting, and may in part define the linkage 182. When the screen 175 is rigid, it may include an integral supporting frame. The supporting frame may keep the screen 175 substantially planar.

The hood 180 is a closure for a compartment 184 at a front of the vehicle 102, in front of the windshield 122. To accommodate the projection screen 175 the hood 180 may be reverse hinged, i.e., hinged at a forward end to open, i.e., lift, at the end closest to the windshield 122, to pivot about its hinges, and expose the compartment 184. The compartment 184 may be, in the case of an internal combustion powered vehicle, an engine bay. The compartment 184 may alternatively be, as in the case of an electric powered vehicle, a forward storage compartment 184, or a frunk 184.

The projection screen 175 is selectively and removably mounted to the vehicle 102. The projection screen 175 is connected at its upper edge to the hood 180 by a support linkage 182. The support linkage 182 may include a plurality of support rods 186, 188, 190. In the example of FIGS. 9 and 10, an upper rod 186 extends between a center connecting location on the hood 180 and an upper connecting point on the upper edge of the projection screen 175. A right lower rod 188 extends between a right connecting location on the hood 180 and a lower right engagement point inside the compartment 184. Similarly, a left lower rod 190 extends between a left connecting location on the hood 180 and a lower left engagement point inside the compartment 184. The lower edge of the screen 175 is attached to each of the right lower rod 188 and the left lower rod 190. The attachment of the lower edge of the screen 175 may be made by, for example, fixing U-shaped brackets to the lower rods 188, 190 via welding or with fasteners to receive the lower edge of the projection screen 175. The connections of the rods 186, 188, 190 at their respective ends may take any form suited to allowing them to be moved to a stored position when the hood 180 is closed and to allow the screen to be moved away from the windshield 122 and stored elsewhere. For example, the lower rods 188, 190 may be pivotably connected at either end, and selectively received in a pocket or a notch on the other end. The lower rods 188, 190 may be pivoted to the illustrated support positions when in use, and folded to a stored position (not shown) for storage in the compartment 184 when not in use. The upper rod 186 may have a first end for and a second end respectively engaging the hood 180 and the upper edge of the projection screen 175. The first end may include an engagement feature for connecting to a complementary engagement feature on the hood 180. Likewise, the second end may include an engagement feature for connecting to a complementary engagement feature on the hood 180. Example complementary engagement features may include an inverted U-shaped bracket and an edge of the screen 175 that fits within the inverted U-shaped bracket, and an eyebolt and hook combination, and a tongue and slot combination. With the rods 186, 188, 190 engaging the hood 180, the screen 175, and the engagement points in the compartment 184, the screen 175 will be consistently located in the design-intent position. While the projection screen 175 has been described as rigid, the linkage 182 may be modified to accommodate a non-rigid projection screen. For example, the projection screen may be a self-storing roll-up projection screen, resembling a window blind. Yet alternatively, the projection screen 175 may be formed of a soft, foldable material. The soft, foldable material of the screen 175 may define a living hinge made of the soft, foldable material comprising part of the screen 175.

To both provide private viewing of the projection image 176 and to substantially eliminate ambient light that might wash out the projection image 176, a darkening shroud 192 may be placed over the screen 175 and the windows of the vehicle 102. The shroud 192 may extend laterally and vertically beyond the projection screen 175 and extend axially toward and beyond the windshield 122. The shroud 192, including the screen 175 if the two are integrated, extends across an entirety of the windshield 122. The shroud 192 may be formed of a soft, foldable material to allow storage of the shroud 192 when not in use, and to protect a surface of the vehicle 102 from being scratched or otherwise marred by the shroud 192. In addition to the soft, foldable material, the shroud 192 may also include rigid or semi-rigid stiffening panels sized to bridge a distance between the upper edge of the screen 175 and a roof of the vehicle 102 to prevent the shroud 192 from sagging into the line of sight of the viewers. The stiffening panels may be foldable to allow easier storage. The soft, foldable material of the shroud 192 may define a living hinge made of the soft, foldable material comprising part of the shroud 192. The living hinge may be located between the stiffening panel and the rest of the shroud, and between the stiffening panels when more than one stiffening panel is included in the shroud 192. The shroud 192 may be held in place by magnets that may be sewn into the shroud 192 with the magnets being drawn against steel body panels. Alternative to magnets may be employed when the vehicle 102 comprised non-ferrous body panels. For example, suction cups may be used in place of magnets. The shroud 192 may also employ hook and loop type strap fasteners and/or tie down strings to engage features of the car such as mirrors to engage vehicle features such as the doors and side view mirrors. The shroud 192 may also comprise multiple pieces, with separate coverings for each door to allow ingress into and egress from the vehicle 102. Clips may be employed to attach door portions of the shroud 192 to the doors. Zippers or hook and loop fastener strips may also be employed where it is desired to join separable portions of the shroud 192. The shroud 192 may also be permanently fixed or selectively removably fixed to a back side of the projection screen 175.

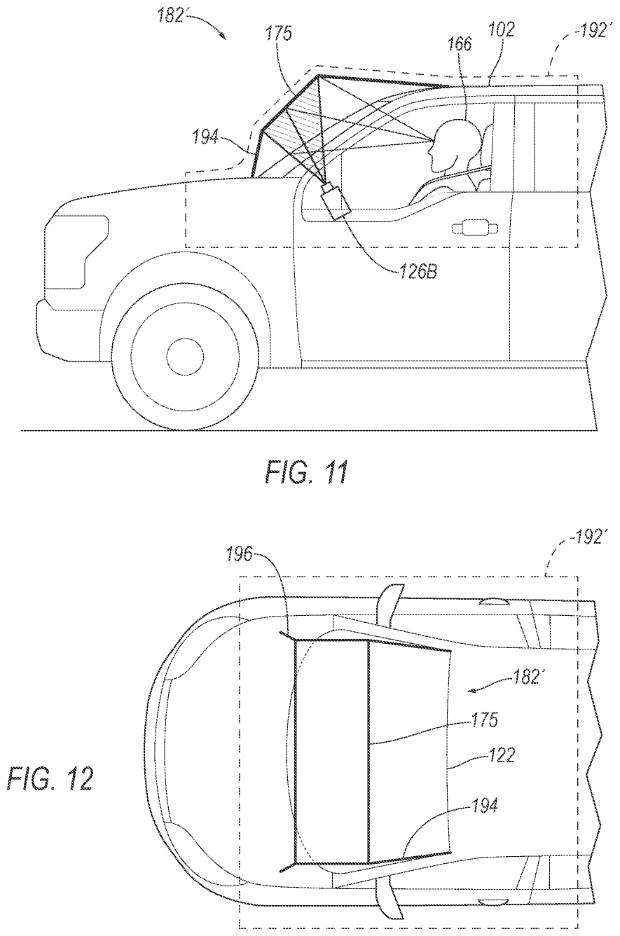

FIGS. 11 and 12 illustrate an example alternative support linkage 182′ for supporting the projection screen 175. As in the example of FIGS. 9 and 10, the screen 175 may be rigid and may define part of the linkage 182′. When the screen 175 is rigid, it may include an integral supporting frame. In addition to the screen 175, the linkage 182′ may also include a left screen support 194 and a right screen support 196. Each may be fixed to the screen 175, with the projection screen 175 being rigid. Each of the left and right screen supports 194, 196 may include a pocket receiving, respectively, a left and a right side of the projection screen 175 when the screen 175 is rigid. The screen supports 194, 196 may each include through-apertures aligned with threaded apertures in the sides of the supporting frame of the projection screen 175. Fasteners, e.g., screws, may pass through the through-apertures in the screen supports 194, 196, and thread into the threaded apertures of the supporting frame of the screen 175. The screen supports 194, 196 are thus connected to each side of the screen 175, and positioned with respect to each other 194, 196. The assembled screen 175 and supports 194, 196 may then be positioned on the vehicle 102 in front of the windshield 122. Many alternative configurations for the linkage 182′ are possible. One example is to, instead of engaging the screen 175 with fasteners, provide transverse support rails that extend laterally between the left and right screen supports 194, 196 to engage an upper edge and a lower edge of the screen 175. The transverse support rails may be each removably fixed to the screen supports 194, 196. Yet alternatively, given a rigid structure for the screen 175, the linkage 182′ may comprise a tripod-type arrangement. For example, a lower right leg may be removably fixed to a lower right corner of the screen 175 and a lower left leg may be removably fixed to a lower left corner of the screen 175. A single upper member may be fixed to a center of the upper edge of the screen 175 for engagement with a roof of the vehicle 102. Yet alternatively, the linkage 182′ may define a frame to which a self-storing roll-up, i.e., rollable, projection screen 175, much like a window blind, may be attached.

Each member of the linkage 182′, including the screen supports 194, 196, rails, and rods may be formed of plastic to be light in weight and resistant to marring a paint finish of the vehicle 102. The linkage members, where they are intended to engage the surface of the vehicle 102, may be tipped with a pliant material, such as a low durometer rubber or vinyl, to resist slipping. Additional resistance to slipping may be achieved by providing suction cups for use at one or more of the tips. Lower end tips of the screen supports 194, 196 may yet alternatively each include a clip to engage an edge of the hood 180 closest to the windshield 122. To ensure the correct positioning of the screen 175, the tips of the linkage members that are to directly engage the vehicle 102 are placed at predetermined locations on the vehicle 102. Such locations may be associated with readily-identified reference points, such as, by way of example, corners of the windshield 122 or corners of the hood 180.

As with the configuration illustrated in FIGS. 9 and 10, a shroud 192′ may be disposed over the upper part of the vehicle 102 and over the screen 175.

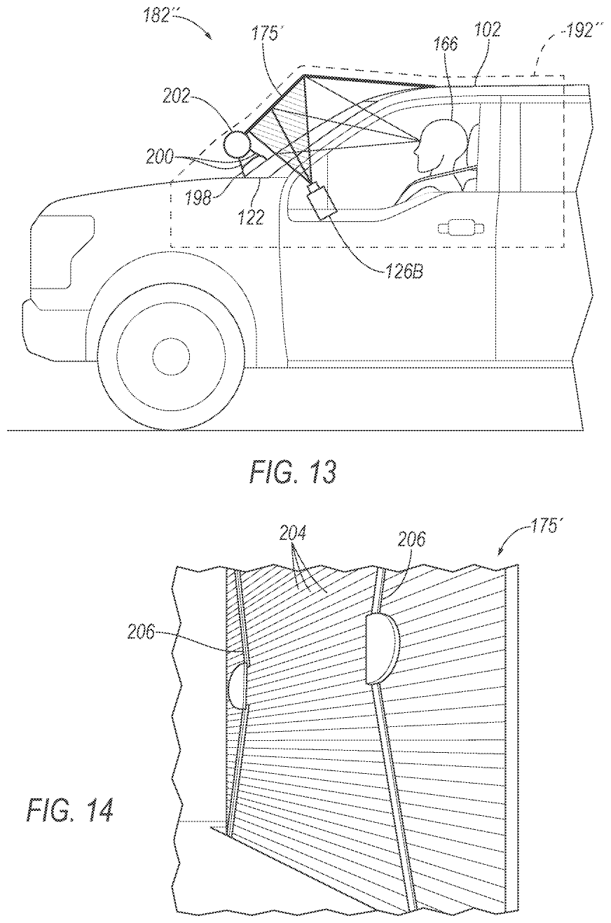

FIGS. 13 and 14 illustrate another alternative support linkage 182″ for a non-rigid projection screen 175′. The extended screen 175′ may be supported by a support base 198 that may be selectively and removably attached to the vehicle 102 by, for example, magnets or suction cups. Support rods 200 may extend vertically to a screen housing 202. The screen 175′, shown in FIGS. 13 and 14 in a fully extended position, comprises a plurality of lateral slats 204. The slats 204 may be supported by a pair of opposed folding beams 206. As the beams 206 straighten, the screen 175′ is extended to its full height H. In a stored position, the screen 175′ is rollable and may be rolled into the housing 202, and the folding beams 206 collapsed into the same housing 202. A screen material may be disposed on a projection side of the slats 204, opposite the folding beams 206. The base 198, the support rods 200, and the housing 202 are all joined, whether separably or fixedly, at predetermined positions and orientations to ensure that when the base 198 is in a predetermined location and the screen 175′ is fully extended, the screen 175′ is in its desired location and orientation.

Alternatively, a support linkage for the non-rigid screen 175′ may incorporate the compartment hood 180 similar to the support of the screen 175 in FIGS. 9 and 10. For example, the screen housing 202 may be supported on the lower rods 188 and 190 and the upper rod 186 may be used to position and stabilize an upper edge of the fully extended screen 175′.

As with the configurations illustrated in FIGS. 9 and 10, and 11 and 12, a shroud 192″ may be disposed over the upper part of the vehicle 102 and over the screen 175′.

The system 100 may be operated in the following manner.

The vehicle 102 is first parked in a suitable area for viewing the images that are to be shared. This may be in a dark environment, such as a garage, or an outdoor location after sunset if it is desired to view the projection image 176 without using the darkening shroud 192, 192′, 192″.

Once the vehicle 102 is parked, the screen 175, 175′ is set up for viewing. The screen support linkage 182 is then put into place. For the arrangement of FIGS. 9 and 10, the hood 180 is opened as a first step. Lifting the hood 180 to the open position may be aided by one or more springs working in concert with the hinges to pivot the hood 180 upward. The springs may maintain the hood 180 in the open position. Alternatively, the hood 180 may be lifted up manually, gripping the hood 180 at or near the edge near the windshield 122 for maximum leverage. Once the hood 180 has been lifted to the open position, it may be supported by a hood prop rod positioned between the hood 180 and the compartment 184. The hood prop rod may serve as one of the lower rods 188, 190. The second of the lower rods 190, 188 may serve as a redundant hood prop rod. Each of the lower rods 188, 190 will be loaded in compression by the weight of the hood 180. When the hood 180 is supported by a spring or springs, the lower rods 188, 190 may similarly be installed, and may either displace the hood 180 slightly further than by the springs alone to load the rods 188, 190, or if the hood 180 is fully displaced by the springs, the rods 188, 190 may be made long enough to be elastically bowed on installation to load the rods in compression. Loading the rods 188, 190 in compression may help in maintaining them in an installed position while the screen 175 is in use. When not in use, the rods 188, 190 may be stored in the compartment 184. One example method of storing the rods 188, 190 may be to have them pivotally attached to the vehicle 102 inside the compartment 184 near the windshield 122. The rods may pivot down laterally, with the upper end of the right lower rod 188 being displaced towards a left side of the compartment 184 and the upper end of the left lower rod 190 being displaced towards a right side of the compartment 184. The upper ends of the rods 188 and 190 may each have a snap spring clip that keeps each rod 188, 190 from moving when not in use.

The rods 188, 190 may be provided with engagement brackets to engage the screen 175.

When the screen 175 is a rigid screen, the brackets may be U-shaped to receive a lower edge of the screen 175. As an alternative to the U-shaped brackets, a U-shaped retaining channel may be removably connected to both rods 188, 190, as by providing the retaining channel with two key-hole slots for alignment and receipt of projections on each of the rods 188, 190. With the rigid screen 175, the top edge of the screen 175 may be retained by placing the upper rod 186 between the hood 180 and the upper edge of the screen 175. The example upper rod 186 may be hinged to the hood 180 near the rear edge of the hood 180, allowing the rod 186 to pivot rearwardly towards the windshield 122. An inverted U-shaped bracket may be attached to an end of the rod 186 opposite the end attached near the edge of the hood 180. The U-shaped bracket may engage the upper edge of the screen 175, holding it at the desired angle δ. When not in use, the upper rod 186 may be pivoted forward, against an inner surface of the hood 180, and retained thereagainst by a snap spring clip.

When the projection screen 175′ is a non-rigid screen of the type is rollable, i.e., that may roll up into a housing 202, the lower rods 188, 190 may include brackets to engage the housing 202. The screen 175′ may then be unrolled from the housing 202 to a support provided by an end of the upper rod 186. When the extended screen 175′ is rigid, i.e., self-supporting, as with the example screen 175′, the upper rod 186 may be configured like that of the above-described configuration, with the rod 186 engaging the upper edge of the screen 175′. When the screen 175 is not rigid when extended, as when the projection screen 175 is a self-storing roll-up projection screen similar to a window blind, the upper rod 186 may benefit from supplemental supporting members extending between the non-hinged end of the rod 186 to the lower rods 188, 190. The U-shaped bracket of the upper rod 186 may face upwards to engage a pull handle on an upper edge of the projection screen 175 to keep the screen 175 in tension.

When the projection screen 175 is formed solely of fabric, it may be provided with sleeves at each of its upper edge and lower edge for receipt of, respectively, removable superior and inferior rods (not shown) extending the width W of the screen. The inferior rod may be engaged by brackets fixed to the lower rods 188, 190. The superior rod may engage the upper rod 186 at the upper edge of the screen 175. The upper rod may be supplemented by the supplemental supporting members extending to the lower rods 188, 190 as described above.

The screen 175, 175′, when not in use, may be, depending on the structure of the screen 175, 175′, placed in a protective pouch, folded and stored in a pouch, rolled up and stored in a pouch, or rolled into its housing, and placed in the compartment 184. With another alternative configuration, if an upper edge of the screen 175 is connected to the hood 180 by a pivoting rod at each end of the screen instead of the center of the screen, the screen may be pivoted back against the hood 180 with the upper rods and strapped to or otherwise fixed to the hood 180 for storage.

The linkage 182′ of FIGS. 11 and 12 may be used to support the screen 175 without having the hood 180 open. When the screen 175 is rigid, as for example, with an integral supporting frame, the left and right screen supports 194 and 196 may be fixed to the screen, and the assembled screen 175 and linkage 182′ placed in front of the windshield 122. When the screen 175 is not rigid, the supports 194 and 196 may be supported by cross members, and the screen 175, 175′, of whatever form, may be supported thereby. Positioning the assembled screen 175 and linkage 182′ may be facilitated by employing readily identifiable reference points as attachment areas. For example, when the lower end tips of the screen supports 194 and 196 are each provided with clips for attaching to the rear or trailing edge of the hood 180, the assembled screen 175 and linkage 182′ may be reliably positioned over the windshield 122 in the desired location.

When not in use, the screen supports 194, 196 may be stored in storage pouches and in turn stored in the compartment 184. The screen supports 194 may each comprise multiple portions that may snap together and are easily separated for more compact storage. Similarly, the cross members, if any, may be formed of multiple connecting pieces to make storage more convenient than storing cross members that may be wider than the compartment 184 is wide.

The linkage 182″ of FIGS. 13 and 14 may support the non-rigid screen 175′ comprising the lateral slats 204 and the folding beams 206. The support base 198 may be first connected to the screen housing 202 by the support rods 200. The assembled support base and housing 202 may be positioned on the windshield 122 or the hood 180 in the predetermined location. The screen 175′ may then be extended from the housing 202. A motor incorporated into the housing 202 may be used to drive the screen 175′ up. Power for the motor may be provided by a battery or batteries also incorporated into the housing 202. Alternatively, power to the motor may be provided by the electrical system of the vehicle via a power cord connecting the motor to an outlet in the vehicle 102. Once the screen 175′ is extended, an upper support rod (not shown) may be disposed from the upper edge of the screen 175′ to the roof of the vehicle 102 to stabilize the position of the screen 175′.

When not in use, the screen 175′ is collapsed into the housing 202, and separated from the base 198 and the rods 200. The rods 200 may be placed in a pouch for storage in the compartment 184. The base and the housing may also be stored in the compartment 184.

With the linkage 182 and the screen 175, 175′ in place, the darkening shroud 192, 192′, 192″ may be placed over the vehicle 102. The darkening shroud 192, 192′, 192″ may be black in color and non-reflective, e.g., matte finish, to increase the light absorption. The shroud 192, 192′, 192″ is unfolded and positioned over at least the side windows and over the open hood 180 to both keep light off of the screen and to darken an interior of the vehicle 102. The shroud 192, 192′, 192″ may also extend to cover the rear window to provide a more complete black-out effect inside the vehicle 102. The shroud 192, 192′, 192″ may be in multiple pieces. Ingress to and egress from the vehicle can be facilitated if individual door panels of the shroud 192, 192′, 192″ are separately clipped to the doors of the vehicle 102. The stiffening panel or panels are aligned with and placed across the gap between the hood 180 in the example of FIGS. 9 and 10, or the upper edge of the screen in the examples of FIGS. 11 and 12 and FIGS. 12 and 13, and the roof of the vehicle 102. As noted, the stiffening panel or panels prevent the shroud 192, 192′, 192″ from sagging into the sight line and blocking the view of the viewers. The shroud 192, 192′, 192″ may be held in place by a plurality of features, including, by way of example clips, tie-downs, magnets, and suction cups.

Once the screen 175, 175′ is set up, and the shroud 192, 192′, 192″, when employed, is in place, the viewers set the vehicle image projection system 100 in the screen projection mode, rather than the HUD projection mode. The viewers may have the option of which of the projectors 126A, 126B, 126C to employ. The driver center projector 126B may be the best positioned of the three projectors to provide the image 176 nearest a center of the screen 175, 175′. The projectors not selected, e.g., projectors 126A, 126C, may be turned off or otherwise prevented from projecting so that any images from the projectors not selected do not interfere with or distract from the projection image 176 on the screen 175. The viewers may also select the viewing material that is to define the projection image 176. Given the choice in viewing material, the viewers may select the channel through which the image is to be communicated to the example selected projector 126B. For example, the user device 104, e.g., a mobile phone of one of the viewers, may provide the image. Alternatively, the image may be available from information stored on an internet server, or in a memory folder of the vehicle computer 120. The system 100 may be programmed to use one of the other projectors, e.g., 126A, 126C to project a supplemental image on one side of the screen 175, or, alternatively, the image 176 may use the selected projector 126B to project a picture-in-picture image, with the supplemental or picture-in-picture image being of activity outside of the vehicle 102. The projection image 176 is larger than the picture-in-picture image, and the picture-in-picture image may occupy one corner of the projection image 176. Data, e.g., live video images, from exterior vehicle cameras 114 may be displayed on the screen in the picture-in-picture, supplemental to the principal image, so that viewers inside of the vehicle 102 are able to maintain an awareness of their immediate surroundings, even though the windows are covered. Additionally, or alternatively, one of the other projectors 126A, 126B may project an image onto the screen 175 of data descriptive of the image from the selected projector 126B. Such descriptive data may include, for example, video run time when the image is a video presentation, projector settings, current time, and so on.

The projection image 176, when uncorrected, may be trapezoidal in shape when the projection screen 175 is not normal to the projection axis 168. To make the image 176 more viewable, the projection image 176 may be keystone corrected to make it more rectangular in shape than an uncorrected shape of the image 176. The focus may also be adjusted to compensate for the projection image 176 being displayed on the screen 175 rather than on the appropriate HUD screen 124A, 124B, 124C. Such keystone correction and focusing of the image 176 may be performed responsive to the signal that the projector(s) is/are in the screen projection mode rather than the HUD projection mode.

Upon completion of the viewing of the material provided in the projection image 176, the projectors 126A, 126B, 126C may be returned to their HUD projection mode so that the HUD screens 124A, 124B, 124C are the selected screens, with the focus being suited therefor and the need for keystone correction likely reduced if not eliminated. After the projection mode reset, the shroud 192, 192′, 192″ may be removed, folded, and stored in the compartment 184. The screen 175, 175′ may then be removed and stored in the compartment 184. The linkage 182, 182′, 182″, is then disassembled, packaged as is appropriate, and stored in the compartment 184.

The use of the vehicle 102 for transportation may then be resumed.

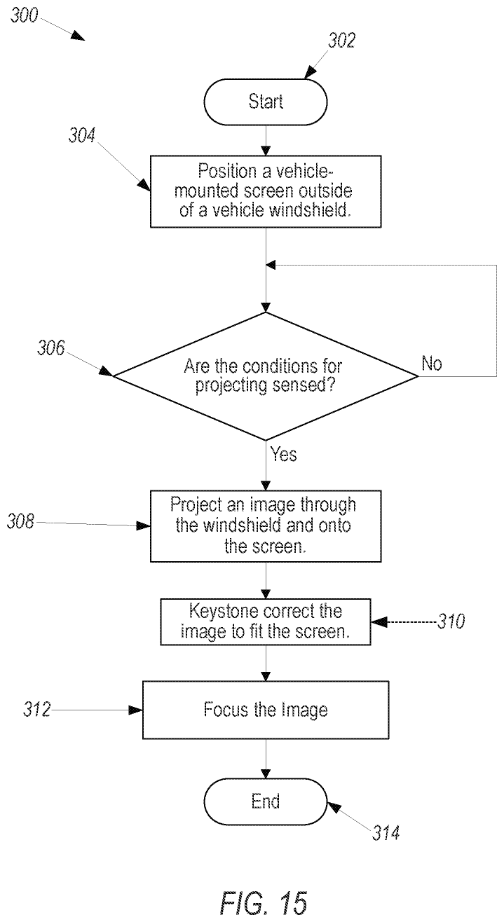

FIG. 15 is a diagram of an example process 300 executed largely in the vehicle computer 120 according to program instructions stored in a memory thereof for detecting conditions indicative of a request for projection of the projection image 176 beyond a windshield 122 of the vehicle by at least one of the TD HUD projectors onto the projection screen mounted, and adjusting projection of the projection image 176 onto the projection screen for viewing by the viewers inside the vehicle 102. The process 300 includes multiple blocks that may be executed in the illustrated order. The process 300 may alternatively or additionally include fewer blocks or may include the blocks executed in different orders.

The process 300 begins in a start block 302. In the block 302, the computing device 120, i.e., the vehicle computer 120, receives data from one or more vehicle sensors 114 via the vehicle network, from the remote server 106 via the network 108, and/or from the user device 104 via the network 108 as discussed above. The process 300 continues in a process block 304.

In the block 304, the projection screen 175 is manually positioned on the vehicle consistent with the above description. The process 300 continues in a decision block 306.

In the block 306, the vehicle computer 120, based on data from the vehicle sensors 114, including for example, the light sensor 114, LIDAR sensors 114, cameras 114, and radar sensors 114, determines whether or not a condition for projection of the image 176 onto the projection screen 175, 175′ beyond the windshield 122, has been sensed. Example conditions for projection of the projection image 176 that may be sensed by the vehicle computer 120 may include one or more of the following. The presence of the projection screen 175 may be sensed. That the vehicle is parked may be sensed. A request to operate at least one of the TD HUD projectors 126A, 126B, 126C in the screen projection mode may be sensed. An appropriate position of the hood 180 (e.g., open or closed) may be sensed. When any required condition for projecting the image 176 onto the screen 175, 175′ is not sensed, the process 300 loops back to the decision block 306 and continues to check whether the condition for projection of the image 176 onto the screen 175, 175′ has been sensed. When any required condition for projecting the image 176 onto the screen 175, 175′ is not sensed, a message may be displayed via one of the TD HUD projectors 126A, 126B, 126C on an associated one of the HUD screens 124A, 124B, 124C advising as to which condition or conditions have not been sensed. When all of the conditions for projection of the image 176 beyond the windshield 122 has been sensed, the process 300 continues in a process block 308.

In the block 308, the vehicle computer 120 directs at least one of the TD HUD projectors 126A, 126B, 126C to project the projection image 176 onto the projection screen 175, 175′. The process 300 continues in a process block 310.

In the block 310, the vehicle computer 120, based on data from the vehicle sensors 114, keystone corrects the projection image 176 on the projection screen 175, 175′ to be less trapezoidal and more rectangular than the projection image is before keystone correction. The process 300 continues in a process block 312.

In the block 312, the vehicle computer 120, based on data from the vehicle sensors 114, focuses the projection image 176 on the projection screen 175, 175′. The process continues in an end block 314.

In the block 314, the process 300 ends.

Operations, systems, and methods described herein should always be implemented and/or performed in accordance with an applicable owner's/user's manual and/or safety guidelines.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A computing device, comprising a processor and a memory, wherein the memory stores instructions executable by the processor such that the computing device is programmed to:
upon detecting conditions suited to do so, project an image from a first vehicle-integrated projector for a heads-up display through a vehicle windshield of a vehicle including a layer of holographic film and onto a projection screen mounted on the vehicle at a predetermined distance beyond the vehicle windshield; and
keystone correct the image to a more rectangular shape than an uncorrected shape; and
focus the image on the projection screen.

2. The computing device of claim 1, wherein, the projection screen is manually positioned at an angle greater than an angle of a plane tangent to the windshield.

3. The computing device of claim 1, wherein, the first vehicle-integrated projector is one of at least three vehicle-integrated projectors positioned to direct respective projection beams toward the windshield and the first vehicle-integrated projector is laterally disposed between the other vehicle-integrated projectors.

4. The computing device of claim 1, wherein, a second vehicle-integrated projector also projects an image onto the projection screen.

5. The computing device of claim 4, wherein, the image projected by the second vehicle-integrated projector includes data descriptive of the image projected by the first vehicle-integrated projector.

6. The computing device of claim 1, wherein, the computing device is further programmed to project a picture-in-picture image within a larger projection image wherein the picture-in-picture image is of video from a vehicle-mounted camera oriented to provide an image of activity outside of the vehicle.

7. The computing device of claim 6, wherein, the vehicle-mounted camera comprises one of a plurality of cameras providing exterior views around the vehicle.

8. The computing device of claim 1, wherein the projection screen is supported by a hood of the vehicle and the hood is in an open position.

9. The computing device of claim 8, wherein the projection screen is fixed to the hood when the hood is closed.

10. The computing device of claim 1, wherein the projection screen is substantially planar and is rigid.

11. The computing device of claim 1, wherein the projection screen is rollable.

12. The computing device of claim 11, wherein the projection screen comprises a plurality of lateral slats.

13. The computing device of claim 1, further comprising a darkening shroud extending laterally and vertically beyond the projection screen and extending axially toward the windshield.

14. The computing device of claim 13, wherein the darkening shroud comprises:
a foldable material defining living hinges; and
a stiffening panel sized to bridge a distance between an upper edge of the projection screen and a roof of the vehicle.

15. The computing device of claim 13, wherein the darkening shroud extends across an entirety of the windshield.

16. The computing device of claim 15, wherein the darkening shroud extends axially from at least the projection screen to rearward of the windshield.

17. A method of projecting images from a vehicle-integrated projector for viewing by a vehicle occupant, the method comprising the steps of:
positioning a vehicle-mounted projection screen a predetermined distance beyond a vehicle windshield of a vehicle including a layer of holographic film;
projecting an image from a first vehicle-integrated projector for a heads-up display onto the projection screen;
keystone correcting the image to a more rectangular shape than an uncorrected shape; and
focusing the image on the projection screen.

18. The method of claim 17, wherein, the projection screen is positioned at an angle greater than an angle of a plane tangent to the windshield.

19. The method of claim 17, wherein, the projection screen is supported by a hood of the vehicle and the hood is in an open position.

20. The method of claim 17, further comprising the step of providing a darkening shroud extending laterally and vertically beyond the projection screen and extending axially toward the windshield.
